(19) United States
(12) Patent Application Publication
(10) Pub. No.: US 2005/0118671 A1
(43) Pub. Date: Jun. 2, 2005

(54) Analysis of vital substances

(76) Inventors: Jurgen Bernhardt, Weinstadt (DE); Felix Oliver Heinrich, Esslingen (DE); Karin Engelhart-Jentzsch, Mannheim (DE)

Correspondence Address: WILLIAM COLLARD;COLLARD & ROE, P.C., 1077 NORTHERN BOULEVARD, ROSLYN, NY, 11576, US

(21) Appl. No.: 10/504,185

(22) PCT Filed: Feb. 12, 2003
(86) PCT No.: PCT/EP03/01359

(30) Foreign Application Priority Data
Feb. 12, 2002 (AT) A 219/02

(51) Int. Cl. G01N 1/30

(52) U.S. Cl. 435/40.52

(57) ABSTRACT

The invention relates to a method of determining the supply profile of at least one micro-nutrient in a biological sample. Cell proteins, in particular cell membrane proteins are removed from the biological sample, in particular after determining the number and/or quantity of cells contained therein, by subjecting the cells to lysis, optionally after isolating them, and micro-nutrients are removed from the lysate, if necessary after denaturing, and their proportion in the sample, in particular their weight, is measured as a measure of the intra-cellular concentration.

The invention relates to a method of determining the supply pattern of at least one micro-constituent in a biological sample and an analysis kit for obtaining and preparing a biological sample incorporating cells for determining the intracellular concentration of at least one micro-nutrient, of the type having the features outlined in the introductory parts of claims 1 and 17 and the use of an analysis kit as defined in claim 18.

People in the industrialised countries have developed an increasing awareness of nutrition and health issues in recent years. However, diseases caused by a deficiency of selected nutrients continue to occur, as they did before, in spite of adequate food supplies. In order to ensure a healthy organism, it is therefore important to recognise a deficiency or excess of specific nutrients and thus compensate for this by supplementing or reducing the intake of nutrients.

Deficiencies in nutrients were recognised for the first time in the 1960s and summarised under the expression “orthomolecular medicine”. The term “orthomolecular” originates from “orthos” (Greek) i.e. correct, good, and “molecule” (Latin)=module of substances. This concept was chosen by two-times Nobel price-winner, Linus Pauling, back in 1968 because it expressed perfectly the principle behind the therapy. The principle of the therapy underlying orthomolecular medicine is based on the recognition that the human body needs vital substances (micro-nutrients), if all its organs are to function healthily and correctly. By this is meant vitamins, minerals, trace elements and essential fatty acids. Orthomolecular treatments are also referred to by the term eubiotics. In the correct dose, they offer optimum health protection.

The active principle is defined by Linus Pauling as follows:

“Orthomolecular medicine is based on maintaining good health and treating diseases by varying the concentration of substances which are normally present in the body and which are responsible for health.”

Health protection and the prevention of disease is based on the administration of ortho-molecular substances in optimum doses. Only substances which occur perfectly naturally in our food and in our body are used in orthomolecular medicine. These include vital substances, such as vitamins and minerals, which our body can not produce or can not produce in sufficient quantities. They therefore have to be administered regularly as micro-nutrients in an appropriate dose, if we are to stay fit and healthy. However, levels of vital substances vary with each individual. The individual level depends on various external and internal factors, such as dietary and living habits, age, state of health and environmental influences. Under certain circumstances, these factors can increase requirements so significantly that the optimum required intake of vitamins and minerals can not be covered in many cases, even with a healthy balanced diet. Vital substances are therefore almost unavoidable. Nowadays, the question of vitamin levels only arises in the case of sick people, in particular persons with chronic diseases. However, it is also important for healthy persons to increase their vitamin level because this will provide important information about a deficiency of a vital substance in the body, thereby enabling diseases which might be caused by deficiencies or excesses, to be recognised at an early stage and prevented. At present, however, treatment to increase vitamin levels is not given other than following a visit to the doctor, providing a blood sample and complex laboratory analysis and has not become a standard part of prophylactic testing due to the amount of time involved and the high costs.

Various different solutions have been proposed in the prior art as a means of analysing vital substances, especially vitamins. One way of achieving these objectives is to determine and quantify micro-nutrients using gas chromatography or mass spectrometry. For example, patent specification U.S. Pat. No. 5,800,979 A describes a method of determining the in vivo concentration of folic acid coenzyme in body fluids. With this method, a known quantity of folic acid is compared, as an internal standard, with the folic acid concentration in a body fluid. This body fluid contains at least one coenzyme. The internal folic acid standard is then purified, the folic acid-coenzyme concentration quantified and an evaluation described by means of gas chromatography or mass spectrometry. The quantification is conducted using biological fluids, such as blood, urea, cerebro-spinal fluid and amnion fluid.

Patent specification EP 840 127 A1 gives a table and a method for testing the vitamin and mineral pattern. A table is given, showing indicator values for vitamins and minerals in the blood. These ranges indicate the target value for a healthy person. The value resulting from a blood analysis is then entered in the table, thereby enabling a record of deficiencies or excesses to be kept. The health status and ageing process of the tested person can be determined on the basis of variances. Water-soluble vitamins, fat-soluble vitamins and minerals from the blood are analysed.

Patent specification WO 95/29628 A1 discloses a method which enables vitamin deficiency to be rapidly detected in a person. The vitamin deficiency is determined by the ability of the person to adjust to darkness, which is tested using various test systems and different light conditions. The analysis data from these tests relating to vitamins can be compared with the results obtained from biological fluids.

Patent specification WO 89/12826 A1 discloses a competitive bonding analysis for vitamin B12 in the serum. Immobilised vitamin B is used for this method, which competes for a bonding partner with vitamin B12 in a sample. The quantity of the bonding partner on the immobilised vitamin B12 is measured and is inversely proportional to the concentration of free vitamin B12 in the sample. The bonding partner is biotinylated and is detected by a reaction with avidin bonded to a reporter group. The immobilised vitamin B12 is bonded to beads by a protein linker, such as an anti-vitamin B12 antibody.

In the prior art, the concentration of micro-nutrients is determined using blood, serum or other body fluids. The disadvantage of these methods is that only the concentration of the circulating vital substances can be demonstrated and not the actual concentration contained in the cell.

Accordingly, the underlying objective of the present invention is top propose a method for increasing the level of micro-nutrients in a cell.

This objective is achieved by the invention as a result of the method incorporating the features defined in the characterising part of claim 1. The advantage of this method resides in the fact that both the extracellular and intracellular concentration of substances is enormously important to the physiological function, such as signal transduction for example, and hence the (patho)physiological state of a cell. Another advantage is the fact that determining the intracellular concentration enables the actual quantity of the micro-nutrient resorbed by the cell to be measured, rather than merely determining the biological availability of both micro-nutrients (eubiotics) and xenobiotics based on the quantity of the substance circulating in the blood. Determining the intracellular concentration has another advantage in that it enables progressive monitoring during a treatment of supplements, for example, thereby avoiding non-selective intake of vital substance preparations, which could lead to an excessive supply of this substance. Furthermore, the whole range of vital substances can be screened before embarking on a course of supplements, so that it can be established which micro-nutrients need to be supplemented.

The embodiment defined in claim 2 is also of advantage because it offers the possibility of an instantaneous increase in levels and ongoing control of each tissue separately, rather than determining the concentration of the entire organism, as is the case if taking a measurement on blood.

Claim 3 defines another advantageous embodiment, which uses an epithelial tissue, in particular a mucosa, which is readily accessible and can be easily removed for analysis, thereby obviating the need for biopsies or for blood samples to be taken.

What has proved to be a further advantage is that this method can also be used for the type of people who buy micro-nutrient products as OTC (over the counter) preparations in any pharmacy without the need for a doctor's prescription, who can then monitor their own levels of micro-nutrients, thereby preventing an over-supply when using these preparations. Yet another advantage is the fact that this method can be implemented simply and rapidly because it dispenses with the need for a blood sample, which requires medically trained personnel, and the method is thereby simplified overall and can reduce costs in the financially over-burdened health system.

The embodiment defined in claim 4 is of advantage, whereby a concentration is determined with various or alternatively with a combination of different analysis methods. Why this has proved to be of advantage is that this analysis method enables concentrations in a plurality of samples to be determined very rapidly.

Another embodiment defined in claim 5 is of advantage, since the concentration of many different substances can be determined. The intracellular concentration of one of these substances or a combination of these substances provides important data with regard to prophylactic treatments for illnesses. However, this data naturally also contains important information about the progress of illnesses, especially chronic illnesses. Another advantage is the fact that by determining several micro-nutrient concentrations, it is often possible to obtain a much broader therapeutic range than is the case if determining xenobiotic concentrations because combining eubiotics produces synergetic effect, as a result of which the pharmacology of the micro-nutrients can be to a certain extent clearly distinguished from drugs which are foreign to the body. Determining a concentration can provide evidence that absorbing a micro-nutrient no longer affords oxidative protection, for example, whereas a combination of two or more micro-nutrients with anti-oxidative properties will exhibit an anti-oxidative effect. Orthomolecular measures initiate biochemical stimuli, which the organism can evaluate and respond to in a meaningful way because the body is dealing with “original parts”, i.e. substances with which it is familiar. This enables early intervention in the metabolism, optimisation of the repair mechanisms, fixing of free radicals and many others.

As defined in claim 6, the method makes it possible to determine a concentration of the amount of vitamins supplied which are vital to important functions of the living being but which can not be synthesised by the metabolism in sufficient quantities and therefore have to be regularly incorporated with the diet. Amongst the specific functions, vitamins are also elements of coenzymes which catalyse the metabolism. It has also proved to be of advantage that, in spite of the very low quantity of vitamins usually needed, it is still possible to highlight specific deficiencies (vitamin deficiency) if there is a drop below a minimum concentration, e.g. night blindness (vitamin A), scurvy (vitamin C), rickets (vitamin D), pernicious anaemia (vitamin B12), Beriberi (vitamin B1) and clotting problems (vitamin K). Too high a supplement of specific vitamins (A, D), on the other hand, can indicate the occurrence of intoxication (hypervitaminoses).

Advantage is also to be had from another embodiment defined in claim 7, whereby determining the concentration of compounds with a retinoid structure enables evidence of biochemical functions associated with sight, growth, development and differentiation of epithelial tissue, reproduction (spermatogenesis, development of the placenta, foetal development) and the production of testosterone, to be highlighted. Concentration detection can provide early evidence of vitamin A deficiencies, especially in high-risk groups such as premature babies, young women and men over 65 years of age. More persistent deficiency due to poor diet, poor digestion and poor absorption (e.g. Morbus Crohn), total parenteral nutrition, pancreatic diseases and alcohol-related diseases can lead to delayed adaptation to the dark, problems with growth, bone formation, grafting and, during pregnancy, abnormal development of the foetus. Vitamin A deficiency tends to be rare in the industrialised countries, but uncontrolled or incorrect self-administration of vitamin A supplements can lead to an increased level of vitamin A concentration, leading to nausea, vomiting, headaches, dry skin and mucous membrane and ultimately also to swelling of the periost, haemorrhaging, hair loss, irritability, spontaneous fractures and teratogenic effects. In the developing countries, vitamin A deficiency is one of the major vitamin deficiencies.

As defined in claim 8, it has also proved to be of advantage to measure the concentration of vitamin B complex, which is responsible for many regulatory functions in the metabolism, thereby enabling these functions to be monitored. Since the human body has only a low capacity for storing this vitamin complex, it is necessary to determine the concentration on a regular basis to ensure wellbeing and maintain physiological functions.

Measuring concentration can highlight supply problems caused by diet, for example a diet based exclusively on rice and cereal products which have been dehusked and polished by machine. During processing, the husk, in which the majority of thiamin is contained, is at least partially removed. Early symptoms of thiamin deficiency are exhaustion, nervousness, poor memory, insomnia, anorexia, abdominal complaints and constipation.

A riboflavin deficiency results primarily from a diet based on insufficient dairy and other animal proteins. Riboflavin deficiency primarily manifests itself in tissues of ectodermal origin.

It has proved to be of advantage to determine a concentration of niacin because a serious niacin deficiency causes pellagra. Primary deficiencies typically occur in areas where maize constitutes the main element of the diet. Bonded niacin, in the form in which if occurs in maize, is not assimilated in the intestine without prior alkali treatment. Signs of pellagra can be observed on the skin, mucous membrane, central nervous system and gastrointestinal tract.

Pantothenic acid is present in many foodstuffs and is an essential component of coenzyme A, which acts as an acyl transfer co-factor in many enzyme reactions, e.g. in the citrate cycle and in the fatty acid cycle, and detecting its concentration can prevent any shift away from physiological equilibrium at an early stage.

Pyridoxin occurs as pyridoxol (alcohol), pyridoxal (aldehyde) and pyridoxamine (amine). These substances fall within the pyridoxin group and have the same effect as vitamins in terms of quality and quantity. Determining the concentration of pyridoxin, which is phosphorylated in the body to produce pyridoxal phosphate, enables early detection of a deficiency or excess of this vitamin, which controls the metabolism of the blood, skin and central nervous system and functions as a coenzyme in many reactions (decarboxylation and transamination of amino acids, de-amination of hydroxyamino acids and cysteine, conversion of tryptophan to niacin and the fatty acid metabolism).

It is particularly important to detect the concentration of folic acid in women of child-bearing age because a shortage of this vitamin can lead to abnormal development of the foetus. Comprehensive studies have shown beyond a doubt that supplementing the diet with folic acid prior to and at the start of a pregnancy is particularly effective in preventing serious developmental malformation of the bony spinal canal (Spina bifida) and other malformations in the spinal bone marrow and brain. The prophylactic effect is not 100% certain but these serious malformations which lead to lifelong invalidity can be prevented in about three quarters of all cases.

Cobalamin is the only vitamin which practically occurs in animal organisms only. Determining its concentration is therefore particularly indicated in the case of vegans who not only consume no meat but also do not eat other animal products such as milk and eggs. Vitamin B12 deficiency is primarily evident in tissue with a high rate of cell division and can influence the biosynthesis of DNA.

Determining the content of biotin, which is an essential coenzyme in the metabolism of both fats and carbohydrates, is of particular advantage because a biotin deficiency manifests itself in the form of retarded mental and physical development, alopecia, kerato-conjunctivitis and breakdown of T and B cell-dependent immunity, so that resultant problems can be prevented if detected early.

Also of advantage is the embodiment defined in claim 9, whereby the concentration of ascorbic acid, which is essential for producing collagen and maintaining substances of mesenchymatous origin (connective tissue, osteoid substance of the bones, dentine of the teeth) is detected, enabling a prophylactic treatment and accompanying measures to be prescribed during chronic illness. The requirement for vitamin C also increases during pregnancy and lactation, in the case of acute inflammatory illnesses, operations and burns, as well as thyreotoxicosis, and detecting a concentration can advantageously provide data to enable a correct dosage of vitamin C supplement to be prescribed. As a strong reducing agent, ascorbic acid can reversibly transfer hydrogen or electrons, and is involved in the phenylalanine and tyrosine metabolism and, as a reducing agent, activates the enzymes which hydroxylyse the proline and lysine of protocollagen after translation to hydroxyproline and hydroxylysine. Vitamin C also causes the release of folic acid from these conjugations, which is coupled with components of nutrients, and also promotes the resorption of iron, and it is therefore advantageous to detect the concentration of ascorbic acid because the resultant dose of vitamin C produces many synergetic effects. Another reason why it is of advantage to detect its concentration is that in adults, a primary deficiency usually occurs due to dietary fads or an unbalanced diet. Particularly cold or hot conditions increase the loss of vitamin C in the urine. Many people assume that eating a lot of fruit and vegetables will guarantee an adequate supply of ascorbic acid. However, it is well known that heat (e.g. during sterilisation of nutrient solutions or during cooking) destroys the vitamin C in foodstuffs and deficiencies can still occur, which can be highlighted by detecting a concentration.

It is also of advantage to detect concentrations of calciferols as defined in claim 10, since these can have serious consequences for human health. The main source of calciferols is the synthesis which takes place in the skin and is dependent on UV light. Provitamin D3 is produced in the skin by photochemical processes involving 7-dehydrocholesterin and is slowly isomerised to produce vitamin D3, which is carried away by a vitamin D-binding protein.

Determining the concentration of calciferols can also help to eliminate the risk of osteoporosis. The main effect of 1,25-dehydroxycholecalciferol is that it increases intestinal calcium resorption and thus promotes normal bone formation and mineralisation.

It has proved to be of advantage to detect evidence of tocopherols, as defined in claim 11, because this enables the prevention of antioxidants, in order to prevent lipid peroxidation of multiple unsaturated fatty acids in the cells and thus maintain membrane stability. Vitamin E also has a close metabolic relationship with selenium. It has proved particularly important to test for concentrations, especially in premature babies, breast-feeding infants and young children who have a diet with a high proportion of unsaturated fatty acids, because a primary tocopherol deficiency can be very quickly detected. In adults, vitamin E deficiency shortens the life of erythrocytes, and leads to keratinuria and ceroid deposits in the muscle cells.

As defined in claim 12, it has proved to be of advantage to detect concentrations of vitamin K to ensure that there is a sufficient quantity to maintain a healthy blood clotting pattern.

Vitamin K deficiency manifests itself in the form of a reduction in the blood's capacity to clot and in a tendency to bleeding (haemorrhaging). Since vitamin K can also be produced by intestinal bacteria in the body, it is of advantage to test for concentration on a regular basis in order to monitor levels of vitamin K.

As defined in claim 13, it has proved to be of advantage to test for the concentration of minerals and trace elements, which are essential for warm-blooded animals. The elements, sodium, potassium, magnesium and calcium in a physiological concentration are responsible for maintaining the homeostasis. The introduction of synthetic diets in the treatment of anomalies of the metabolism due to inherited genetic defects, the development of intravenous feeding and dialysis treatment of patients with kidney insufficiency cover the iatrogenic risks illustrates the importance of determining concentrations so that these elements can be supplemented. Trace elements, which occur in the body in minimal concentrations (less than 0.005% of body weight), play an important role in human physiology. However, the increase in the development of synthetic foods has led to an excessive intake of these elements, which leads to symptoms of toxicity, although these may not necessarily come to light until years later. For example, many health magazines and reform organisations sing the praises of Dolomite stone on the grounds that it is rich in calcium and magnesium. Broad sectors of the population are receptive to this type of information. However, published statements point out that Dolomite stone also contains metals, such as iron, chromium, phosphorous, nickel, silicon, zinc and cadmium in potentially toxic concentrations. The method proposed by the invention offers particular advantages in situations involving such complex effects of minerals and trace elements because it is able to detect a plurality of micro-nutrients.

Other advantages are defined in claim 14, in that detecting the concentration of these substances is an important indicator for the wellbeing of humans. For example, taurine, which is an essential amino acid and is found in the tissue of most animal species, is not present as a building block of proteins but is present in a free form in many tissues. Taurine is involved in a series of physiological processes, e.g. the conjugation of gallic acid, osmo-regulation, detoxification of xenobiotics, stabilisation of cell membranes, control of the cellular calcium flow and modulation of neuronal stimulation. A reduced taurine level has been associated with degeneration of the retina, retarded growth and cardiomyopathy.

Determining the concentration of acetyl-L-carnitine is of advantage because it promotes the absorption of acetyl coenzyme A in the mitochondria during fatty acid oxidation, enhances the production of acetyl choline and stimulates the synthesis of proteins and membrane phospholipids. Due to its structural similarities with acetyl choline, acetyl-L-carnitine also serves as a parasympatomimeticum. A high concentration of acetyl-L-carnitine also has a positive effect on the progress of Morbus Alzheimer, senile dementia, HIV infection, diabetic neuropathy, cerebral ischaemia and in alcohol-induced cognitive problems.

Another advantage is the fact that experimental studies have provided evidence that quercetin acts on the human organism in many ways and determining the concentration of this micro-nutrient can provide important information about the general wellbeing of a person. For example, it protects the heart-circulatory system, counteracts the occurrence of carcinomas and ulceration, prevents allergic reactions, prevents the development of cataracts and has an anti-viral and anti-inflammatory effect.

It has also been found to be of advantage to detect the concentration of bromelain, and this is of special benefit to persons with clotting problems and a weakened immune system. The antiphlogistic effect of bromelain is based on various physiological mechanisms. One proven origin is the fact that the production of bradikinin at the site of the inflammation is inhibited due to exhaustion and fibrin formation is suppressed due to the reduction of specific intermediate products of the clotting system. Furthermore, bromelain has been shown to promote the conversion of plasminogen into plasmin and thus stimulate fibrinolysis.

As a result of the embodiment of the method defined in claim 15, determining the concentration of amino acid can highlight a deficiency of biologically valuable proteins. Amino acids are building blocks of proteins and hormones. A deficiency of essential amino acids leads to a breakdown of the physiological function of the human body. For example, arginine raises the lymphocyte count and generally promotes the formation of immuno-competent cells. It also increases the cytolytic capacity of macrophages and NK-cells. In addition, it plays an important role in healing wounds. Histidine acts as an anti-allergic and is also a precursor of histamine. Isoleucine, leucine and valine are important elements of muscle proteins. Lysine is the main element of collagen, carnitine antibodies, hormones and enzymes, assists the healing of wounds and promotes healing of Herpes simplex. Methionine is an antioxidant, detoxifies the liver and is essential for the action of selenium (absorption, transport, bio-availability). Phenylalanine has an anti-depressive effect and prolongs the action of and increases the activity of endorphins. Threonine is a lipotropic factor. Tryptophan is important in the synthesis of vitamin B3 and is a precursor of serotonin and melatonin (sleep rate).

As defined in claim 16, the concentration of essential fatty acids can be determined. For the organism, optimum concentration of essential fatty acids is particularly important during growth and is extremely important in the second half of life. For example, they ensure the elasticity of the membranes of all body cells and the mitochondria and are responsible for cell regeneration. They are also needed by the immune system for building defensive and attacker cells. They occur in the gonads and form the building blocks for the body's own hormone production in the endocrine gland system but also in the cell tissue. Amongst the essential fatty acids which play a very important role are linoleic and α-linolenic acid. They serve as a structural element of the cell membrane and, in conjunction with the products to which they give rise, such as prostaglandin, thromboxane and leukotriene, they control many processes in the organism which are important to life. Arachidonic acid only occurs in animal fats and is a starting product for prostaglandin synthesis. An excess of arachidonic acid can have a negative effect on rheumatic joint inflammation.

The objective of the invention is also independently achieved by means of an analysis kit incorporating the features defined in the characterising part of claim 17. The advantage of this approach is that the analysis kit contains the equipment and all necessary reagents for obtaining and storing mucosa cells. Another advantage is the fact that the analysis kit is very easy to store to the degree that it can be stored at home at room temperature.

The objective of the invention is also independently achieved by using the analysis kit incorporating the features defined in the characterising part of claim 18. The advantage here is that use of the analysis kit enables a concentration of micro-nutrients to be determined rapidly and without difficulty.

A description will now be given below, on the basis of examples, of how the concentration of a plurality of possible micro-nutrients can be determined, although it should be pointed out that it would naturally also be possible to determine the concentration of micro-nutrients other than those specifically described in the examples of embodiments and these are also included within the scope of the invention. Although not explicitly listed, it will be evident to the skilled person that these other micro-nutrients whose concentrations can be determined also form part of the teaching of the invention and are therefore included in its protective scope.

The percentages given in the text below are given on the basis of % by weight.

Taking Samples of Mucosa Cells

To obtain buccal mucosa cells, the mouth must be rinsed several time, for example with sterile water, physiological sodium chloride solution (0.9% NaCl), phosphate-buffered salt solution (PBS), etc., in a volume selected from a range of from 10 ml to 1000 ml, in particular 50 ml to 500 ml, preferably 100 ml to 250 ml. A wooden or plastic spatula, a stick such as a cotton bud, or a brush, e.g. a toothbrush, is moistened with PBS or 0.9%-strength NaCl solution and then scraped or brushed across the inside of each cheek from top to bottom with a light pressure 10 times to 30 times, preferably 15 times to 20 times. It is important not to swallow the saliva during scraping or brushing. The mouth is rinsed one to 5 times, preferably 2 times to 3 times with PBS, 0.9%-strength NaCl or water in a volume selected from a range of from 5 ml to 100 ml, in particular 10 ml to 50 ml, preferably 20 ml to 30 ml, and the rinse liquid is caught in a sample vessel. The spatula or brush is also rinsed in this solution and wiped around the edge of the sample vessel. Buffer solution or water may optionally already be placed in the sample vessel. However, the sample vessel may also contain reagents for stabilising or lysing the cells in the rinse liquid. The sample vessel is then cooled. This may be done either in a cooling appliance, such as a refrigerator or deep freezer, or in a container such as an aluminium bag, a polystyrene box or cooler bag in which ice or frozen cooler blocks are placed, for example. It must be transported to the laboratory in the cooled state.

In the laboratory, the rinse liquid in the sample vessel is centrifuged. This centrifugation is continued for 30 minutes, preferably 20 minutes, in particular 10 minutes, at 2000 g, preferably 1500 g, in particular 1400 g, in a temperature range of between −10° C. and 15° C., preferably between 0° C. and 10° C., in particular between 4° C. and 8° C.

The top phase is decanted and the cell pellet is washed and re-suspended in 30 ml, preferably 25 ml, in particular 20 ml of PBS, preferably in cold PBS. It has proved to be of advantage to use a volume of 15 ml, in particular 10 ml. The homogenised cells are centrifuged again for a period of from 1 minute to 15 minutes, in particular 2 minutes to 10 minutes, preferably 3 minutes to 5 minutes at 1000 g, in particular 1400 g, preferably 1800 g. The centrifugation step is operated at a temperature in a range of from −10° C. to 20° C., in particular −5° C. to 15° C., preferably 0° C. to 10° C. It has proved to be of advantage to select a temperature from the range of between 2° C. and 8° C., in particular between 4° C. and 6° C.

The top phase is again decanted and the cell pellet is placed in PBS, 0.9%-strength NaCl solution or water. The volume of the solution for re-suspending the pellet is in a range of between 0.5 ml and 5 ml, in particular between 1 ml and 3 ml, preferably between 1.25 ml and 2 ml. Homogenisation takes place with a 10 ml, preferably a 5 ml pipette and even better homogenisation can be obtained with a 1 ml, preferably a 0.5 ml pipette. The cells are centrifuged again for a period of from 0.5 minute to 5 minutes, in particular 1 minute to 4 minutes, preferably 1.5 minutes to 3 minutes, at 10,000 g, preferably 15,700 g, in particular 18,000 g.

The top phase is drawn off and the cell pellet is exposed to nitrogen for a period of from 1 s to 60 s, preferably 5 s to 30 s, in particular 10 s to 20 s, and then frozen at −20° C., preferably at −80° C. During the final re-suspension step, the homogenised solution can also be topped up, for example to 500 μl or 400 μl or 300 μl portions, The cell pellet is either frozen or processed directly.

The mucosa cells may also be obtained from other mucous membranes using standard methods described in the technical background literature.

Instead of mucosa cells, it would naturally also be possible to use blood cells as a means of determining the intracellular supply pattern of at least one micro-nutrient. The blood cells are isolated using a standard isolation procedure of the type described in the background literature or for example are isolated with analysis kits sold by the Qiagen company in order to purify the blood cells.

Prior to lysing the cells, the cell count is determined by means of known cell counting methods, for example by counting cells using a counting chamber in conjunction with a microscope or by an automatic counting method, e.g. using a Coulter counter.

Lysing the Cells

The isolated mucosa cells are subjected to lysis. The cell pellet in the first sample vessel is re-suspended in a volume of 50 to 100 μl, preferably 100 to 300 μl, in particular 200 μl to 250 μl PBS, 0.9%-strength NaCl solution or water. Ethanol is then added in a volume of from 50 μl to 500 μl, in particular 100 μl to 300 μl and preferably from 200 μl to 250 μl displaced with sodium dodecyl sulphate (SDS) and butylated hydroxytoluene (BHT) respectively in a concentration selected from a range of from 0.1% to 10%, preferably 0.5% to 5%, in particular 1% to 2%. The solution is then mixed, preferably vortexed, for a period selected from a range of from 1 s to 60 s, in particular 10 s to 50 s, preferably 30 s to 40 s.

Preparing the Sample for High-Pressure Liquid Chromatography (HPLC)

n-hexane is then added in a volume of from 100 μl to 1000 μl, in particular 200 μl to 800 μl, preferably 300 μl to 400 μl, followed by further mixing, preferably vortexing, for a period of from 1 s to 60 s, preferably 5 s to 50 s, in particular 10 s to 20 s. The solution is centrifuged for a period selected from a range of from 10 s to 5 minutes, preferably 30 s to 3 minutes, in particular 1 minute to 2 minutes, at 1000 g, preferably 10,000 g, in particular 16,000 g. After centrifugation, the n-hexane phase is pipetted off into a second sample vessel. The original first sample vessel is in turn coated with n-hexane in a volume of from 100 μl to 1 ml, preferably 200 μl to 500 μl, in particular 300 μl to 400 μl. For a period selected from a range of from 1 s to 60 s, in particular from 5 s to 50 s, and preferably from 10 s to 30 s, the solution is vortexed and then centrifuged for a period selected from a range of from 10 s to 5 minutes, preferably 30 s to 3 minutes, in particular 1 minute to 2 minutes, at 1000 g, preferably 10,000 g, in particular 16,000 g. The top phase is again removed and pipetted into the same second sample vessel to which the previous phase was transferred and the top phases of the first and second centrifugation steps are combined. Preparation of the sample is completed by complete evaporation in the nitrogen flow (evaporator). The cell pellet is re-suspended in liquid in a volume selected from a range of from 10 μl to 1000 μl, in particular 100μ to 500 μl and preferably 200 μl to 300 μl and pipetted into micro-inserts of auto-sampler vials.

Implementing HPLC

A description will be given on the basis of selected examples from a plurality of variable parameters applied for implementing the HPLC but it should be pointed out that it would naturally also be possible to adopt parameters other than those specifically described in the examples below, which should also be construed as falling within the scope of the invention.

The column used for the HPLC is a Nucleosil 120, C 18, 300×3 mm column. Liquid A consists of acetonitrile, methanol and ammonium acetate in a concentration selected from a range of from 0.1% to 10%, in particular 1% to 5%, preferably 2% to 3%. The substances in liquid A, acetonitrile: methanol: ammonium acetate, are present in a ratio of 171:29:15, in particular 171:17:7, preferably 163:21:19. Tetrahydrofuran (THF) is used as liquid B. For the liquid chromatography, an eluting agent gradient is generated using one of the three approaches set out below.

| Time [min] | % A | % B |
|---|---|---|
| 0 | 90 | 10 |
| 4 | 90 | 10 |
| 10 | 80 | 20 |
| 16 | 70 | 30 |
| 16.5 | 80 | 20 |
| 20 | 100 | 0 |
| 0 | 100 | 0 |
| 4 | 100 | 0 |
| 10 | 70 | 30 |
| 16 | 70 | 30 |
| 16.5 | 100 | 0 |
| 20 | 100 | 0 |
| 0 | 100 | 0 |
| 4 | 80 | 20 |
| 10 | 60 | 40 |
| 16 | 70 | 30 |
| 16.5 | 80 | 20 |
| 20 | 90 | 10 |

The flow rate is within a range selected from between 0.1 ml/minute and 5 ml/minute, in particular 0.2 ml/minute and 4 ml/minute and preferably between 0.5 ml/minute and 3 ml/minute. It has been found to be of particular advantage to opt for a range of between 0.6 ml/minute and 2 ml/Minute, in particular between 0.8 ml/minute and 1.5 ml/minute. UV light is used for detection purposes together with visible light, respectively with a wavelength selected from a range of between 282 nm and 396 nm, in particular between 293 nm and 348 nm, in particular between 298 nm and 326 nm, in the case of UV light and selected from a range of between 400 nm and 800 nm, in particular between 456 nm and 721 nm, preferably between 532 nm and 678 nm, in the case of visible light. The temperature during liquid chromatography is in a range of between 20° C. and 60° C., in particular 30° C. to 50° C. and preferably between 40° C. and 45° C. An internal standard is also added to liquid A to enable the HPLC system to be calibrated.

### EMBODIMENT 1

Determining the Tocopherol Supply Profile in Buccal Mucosa Cells

Buccal mucosa cells are obtained by rinsing the mouth several times with a total of 500 ml PBS, for example. A brush, for example a toothbrush, is moistened with PBS and then brushed with a light pressure from top to bottom along the inside of each cheek 10 times. It is important that the saliva should not be swallowed during brushing. The mouth is rinsed out once with 50 ml of PBS and the rinse liquid caught in a sample vessel. 10 ml of buffer solution have already been placed in the sample vessel beforehand. In addition, the brush is also rinsed in this solution and wiped around the edge of the sample vessel. The sample vessel is then cooled. This is done in a refrigerator. Transport to the laboratory is by means of a polystyrene box filled with ice cubes.

In the laboratory, the rinse fluid in the sample vessel is centrifuged for 30 minutes at 2000 g and at a temperature of 0° C. The top phase is decanted and the cell pellet re-suspended in 30 ml PBS. The homogenised cells are centrifuged again for a period of 1 minute at 1800 g. Centrifugation takes place at a temperature of 0° C. The top phase is decanted again and the cell pellet placed in 0.5 ml of PBS with a 1 ml pipette. The cells are centrifuged for a further 5 minutes at 10,000 g. The top phase is drawn off and the cell pellet exposed to nitrogen gas for 30 s.

Lysing the Cells

The cell pellet in the sample vessel is re-suspended in a volume of 100 μl PBS. 100 μl Ethanol displaced with 0.5% SDS and 0.5% BHT is then added and the solution is vortexed at 30 s.

Preparing the Sample for HPLC

The sample is prepared for HPLC by adding 300 μl of n-hexane and the sample is vortexed again for 30 s. The solution is then centrifuged for a further 3 minutes at 10,000 g. After centrifugation, the n-hexane phase is then pipetted off into a second sample vessel. The original first sample vessel is in turn coated with 300 μl of n-hexane, vortexed for 30 s and centrifuged for 3 minutes at 10,000 g. The top phase is removed again and pipetted into the same second sample vessel as that into which the phase was previously transferred and the top phases of the first and the second centrifugation step are combined. Preparation of the sample is completed by a total evaporation of the sample with nitrogen. The pellet is re-suspended in 300 μl of liquid and pipetted into micro-inserts of autosampler vials.

Implementing HPLC

The column used for HPLC is a Nucleosil 120, C 18, 300×3 mm column. Liquid A consists of acetonrile, methanol and 5% ammonium acetate. The substances of liquid A, acetonitrile:methanol:ammonium acetate, are used in a ratio of 163:21:19. THF is used as liquid B. The following elution gradient is used for the liquid chromatography.

| Time [min] | % A | % B |
|---|---|---|
| 0 | 90 | 10 |
| 2 | 90 | 10 |
| 5 | 80 | 20 |
| 10 | 70 | 30 |
| 14 | 80 | 20 |
| 15 | 100 | 0 |

The flow rate is 0.5 ml/Minute and detection is operated using UV-VIS at 292 nm and 456 nm. The temperature during the liquid chromatography is 20° C. An internal standard is also added to liquid A to enable the HPLC system to be calibrated.

### EMBODIMENT 2

Determining the Folic Acid Content of Vaginal Mucosa Cells

To obtain vaginal mucosa cells, the vagina is rinsed several times, for example with a total of 200 ml of water. A stick, e.g. a cotton bud, is moistened with water and the cells wiped from the vaginal mucous membrane with a light pressure. The vagina is rinsed again with 20 ml of water and the rinse liquid is caught in a sample vessel. The cotton bud is rinsed in the rinse liquid in order to detach any cells which might be adhered to it. The sample vessel is then cooled in the refrigerator at 4° C. Transport to the laboratory is by means of a cooler bag filled with frozen cooling blocks.

In the laboratory, the rinse liquid in the sample vessel is centrifuged for 20 minutes at 1500 g and at a temperature of 15° C. The top phase is decanted and the cell pellet re-suspended in 20 ml of water. The homogenised cells are centrifuged for a further period of 10 minutes at 1000 g. Centrifugation takes place at a temperature of 15° C. The top phase is decanted again and the cell pellet placed in 1 ml of water with a 5 ml pipette. The cells are centrifuged for a further 4 minutes at 18,000 g. The top phase is drawn off and the cell pellet exposed to nitrogen gas for 1 minute.

Lysing the Cells

The cell pellet in the sample vessel is re-suspended in a volume of 50 μl of water. 50 μl Ethanol displaced with 2% SDS and 2% BHT is then added and the solution vortexed for 40 s.

Preparing the Sample for HPLC

The sample is prepared for HPLC by adding 200 μl of n-hexane and the sample is vortexed for a further 40 s. The solution is then centrifuged for 2 minutes at 10,000 g. After centrifugation, the n-hexane phase is pipetted off into a second sample vessel. The original sample vessel is in turn coated with 200 μl of n-hexane, vortexed for 40 s and centrifuged for 2 minutes at 10,000 g. The top phase is removed again and pipetted into the same second vessel as that to which the phase was previously transferred and the top phases of the first and the second centrifugation step are combined. Preparation of the sample is completed by completely evaporating the sample with nitrogen. The pellet is re-suspended in 300 μl of liquid and pipetted into micro-inserts of autosampler vials.

Implementing HPLC

The column used for the HPLC is a Nucleosil 120, C 18, 300×3 mm column. Liquid A consists of acetronitrile, methanol and 1% ammonium acetate. The substances of liquid A, acetonitrile:methanol:ammonium acetate, are used in a ratio of 171:29:15. THF is used as liquid B. The following liquid gradient was used for the liquid chromatography.

| Time [min] | % A | % B |
|---|---|---|
| 0 | 100 | 0 |
| 5 | 80 | 20 |
| 8 | 60 | 40 |
| 10 | 70 | 30 |
| 16 | 80 | 20 |
| 22 | 90 | 10 |

The flow rate is 1 ml/minute and detection is by UV-VIS at 292 nm and 456 nm. The temperature during liquid chromatography is 20° C. An internal standard is also added to liquid A to enable the HPLC system to be calibrated.

### EMBODIMENT 3

Determining Supply Profile in Buccal Mucosa Cells

The cells are obtained in the same way as descried in embodiments 1 and 2 and lysed. After lysing the cells, the elements dissolved in the cell top phase are pumped to an atom absorption device, where the concentration of calcium is analysed in accordance with the operating instructions for the respective apparatus used.

### EMBODIMENT 4

Determining the Magnesium Supply Profile in Buccal Mucosa Cells

The cells were obtained in the same way as that described in embodiments 1 and 2 and lysed. After lysing the cells, the concentration of magnesium is determined by mass spectrometry with inductively coupled plasma in accordance with operating instructions of the respective apparatus used. The individual ions are detected by ICP-MS on the basis of mass separation so that very small quantities of the element can be detected.

It would naturally also be possible to use cells that are not of human origin as the biological material, such as animal or plant cells for example, to determine the supply profile with at least one micro-nutrient.

As mentioned above, the examples of possible concentrations which can be determined should not construed as restricting the scope of the invention in any way.

1-18. (canceled)

19. Method of determining the concentration of micro-nutrients in a biological sample, in particular in buccal mucosa cells, wherein samples of mucosa cells are obtained, optionally stabilised, centrifuged, the top phase is decanted, the cells are again re-suspended and centrifuged, the cell membrane is broken down, the cellular elements are separated by centrifugation, a chromatographic method is used for separation purposes and the intracellular micro-nutrient profile of the mucosa cells is determined by an analysis method.

20. Method as claimed in claim 19, wherein cells from an epithelial tissue are used as the biological sample, in particular a mucosa, such as buccal mucosa cells, vaginal mucosa cells, cervical mucosa cells, etc.

21. Method as claimed in claim 19, wherein the micro-nutrient profile is measured by an analysis process selected from a group consisting of high-pressure liquid chromatography (HPLC), gas chromatography (GC), ion chromatography, atom absorption spectrometry (AAS), inductively coupled plasma analysis mass spectrometry (ICP-MS), capillary electrophoresis (CE), mass spectrometry (MS), etc.

22. Method as claimed in claim 19, wherein the micro-nutrient is at least one substance selected from a group consisting of provitamins, vitamins, minerals and trace elements, amino acids, fatty acids, polyphenols, hormones and organ extracts and their synthesis products, such as pancreatin, gallic acid, cartilage base substance, etc., for example.

23. Method as claimed in claim 22, wherein the micro-nutrient is a vitamin selected from a group consisting of natural and synthetic compounds with a retinoid structure (A vitamins), vitamin B complex, ascorbic acids (C vitamins), calciferols (D vitamins), tocopherols (E vitamins), K vitamins, flavonoids and biotin

24. Method as claimed in claim 22, wherein the micro-nutrient is at least one compound with a retinoid structure selected from a group consisting of retinol, retinyl acetate, retinyl palmitate, 3,4-didehydroretinol (vitamin A2), retinal, retinic acid and provitamins, such as α-, β-, γ-carotene, for example.

25. Method as claimed in claim 22, wherein the micro-nutrient is at least one compound of the vitamin B complex selected from a group consisting of thiamin (vitamin B1) or thiamin hydrochloride or thiamin monomitrate, riboflavin (vitamin B2) or sodium-riboflavin-5-phosphate, niacin (vitamin B3) or nicotinic acid or neacin, pantothenic acid (vitamin BS) or calcium-D-pantothenate or sodium-D-pantothenate or D-panthenol, pyridoxin (vitamin B6) or pyridoxin hydrochloride or pyridoxin-5-phosphate or pyridoxin dipalmitate or pyridoxal phosphate, folic acid (vitamin B9) or pteroyl glutamic acid, cobalamin (vitamin B12) or cyanocobalamin or hydroxycobalamin, biotin, choline, inositol and p-aminobenzoic acid.

26. Method as claimed in claim 22, wherein the micro-nutrient is at least one compound of ascorbic acids selected from a group consisting of L-ascorbic acid, sodium-L-ascorbate, calcium-L-ascorbate, potassium-L-ascorbate and L-ascorbyl-6-palmitate.

27. Method as claimed in claim 22, wherein the micro-nutrient is at least one compound of calciferols selected from a group consisting of ergocalciferol (vitamin D2), cholecalciferol (vitamin D3), 1,25-dihydroxycholecalciferol and the provitamins ergosterol or 7-dehydrocholesterol.

28. Method as claimed in claim 22, wherein the micro-nutrient is at least one compound of tocopherols selected from a group consisting of D-α-tocopherol, DL-α-tocopherol, D-α-tocopheryl acetate, DL-α-tocopheryl acetate and D-α-tocopheryl acid succinate.

29. Method as claimed in claim 22, wherein the micro-nutrient is at least one compound of K vitamins selected from a group consisting of phylloquinone (vitamin K1), menoquinone (vitamin K2), menadione (vitamin K3) and menadione hydroxyquinone (vitamin K4).

30. Method as claimed in claim 22, wherein the micro-nutrient is at least a mineral or trace element selected, in order of their importance to the organism, from a group consisting of Na, K, Mg, Ca, Fe, I, Cu, Mn, Zn, Co, Mo, Se, Cr, F, Si, Ni, As, Sn, V, P, Cl, B, Al and Br.

31. Method as claimed in claim 22, wherein the micro-nutrient is at least one component from a group consisting of coenzyme Q-10, quercetin, bromelain, inositol, choline, pycnogenol, carnitine, taurine, mesoinositol.

32. Method as claimed in claim 22, wherein the micro-nutrient is at least one essential amino acid selected from a group consisting of histidine, isoleucine, leucine, lysine, methionine, phenylalanine, threonine, tryptophan, valine and arginine.

33. Method as claimed in claim 22, wherein the micro-nutrient is at least one fatty acid selected from the group consisting of linoleic acid, linolenic acid and arachidonic acid.

34. Analysis kit for obtaining and preparing a biological sample with cells for determining the intracellular concentration of at least one micro-nutrient for use in a method as claimed in claim 19, comprising a sample-taking device such as a spatula, a brush, a stick, a capillary, for example, as well as a sealable sample vessel, optionally including at least one reagent selected from the group consisting of water, a buffered salt solution, a 0.9%-strength NaCl solution, a stabiliser and a detergent, in particular a lysis reagent, and optionally an insulated container for accommodating the sample vessel, in particular for cooling the sample vessel with the cells.

35. Use of the analysis kit as claimed in claim 34 for despatching the biological sample obtained by non-invasive means to an analysis institute.
